(19) United States
(12) Patent Application Publication
(10) Pub. No.: US 2005/0201606 A1
(43) Pub. Date: Sep. 15, 2005

(54) 3D segmentation of targets in multislice image

(76) Inventors: Kazunori Okada, Plainsboro, NJ (US); Dorin Comaniciu, Princeton Jct., NJ (US); Arun Krishnan, Exton, PA (US)

Correspondence Address: Siemens Corporation;Intellectual Property Department, 170 Wood Avenue South, Iselin, NJ, 08830, US

(21) Appl. No.: 10/991,683

(22) Filed: Nov. 18, 2004

Related U.S. Application Data
(60) Provisional application No. 60/552,481, filed on Mar. 12, 2004.

(51) Int. Cl. G06K 9/00; G06K 9/34

(52) U.S. Cl. 382/131; 382/173

(57) ABSTRACT

A method for three-dimensional segmentation of a target in multislice images of volumetric data includes determining a center and a spread of the target by a parametric fitting of the volumetric data, and determining a three-dimensional volume by non-parametric segmentation of the volumetric data iteratively refining the center and spread of the target in the volumetric data.

This application claims priority to U.S. Provisional Application Ser. No. 60/552,481, filed on Mar. 12, 2004, which is herein incorporated by reference in its entirety.

### BACKGROUND OF THE INVENTION

1. Field of the Invention

The present invention relates to volumetric image data characterization, and more particularly to a system and method for 3D segmentation of targets in multislice images.

2. Description of Related Art

One goal of the computer-assisted diagnosis with the chest CT scans (chest CAD) is reliable volumetric measurement of the pulmonary nodules. Tumor change qualification based on such volume measurements plays an integral part of the cancer therapy monitoring and post-surgical examinations. There are a number of previous studies addressing the computer-assisted volume measurement of nodules. In these studies, the 2D or 3D tumor segmentation based on voxel intensity thresholding is used as the foundation of their solutions. Although such solutions are sufficient to delineate the well-defined solid nodules with similar average intensity, they provide unreliable segmentation for the part- or non-solid nodules, as shown in FIGS. 1A-B. A recent clinical study has revealed that such nodules occur frequently and have a higher tendency to be malignant, motivating the development of the robust solution for these technically challenging cases.

FIGS. 1A-B illustrate 2D examples of the pulmonary nodule segmentation. FIG. 1A: 2D profile of two nodule examples, FIG. 1B: segmentation results by the full-width at half-maximum (FWHM) intensity thresholding. The intensity thresholding method has been shown to fail for the non-solid case.

Therefore, a need exists for a system and method for 3D segmentation of targets in multislice images.

### SUMMARY OF THE INVENTION

According to an embodiment of the present disclosure, a method for three-dimensional segmentation of a target in multislice images of volumetric data comprises determining a center and a spread of the target by a parametric fitting of the volumetric data, and determining a three-dimensional volume by non-parametric segmentation of the volumetric data iteratively refining the center and spread of the target in the volumetric data.

Determining the center and the spread of the target comprises providing a marker in the volumetric data for an initial target location, determining a region around the initial target location, modeling the region around a spatial extremum, and determining the center and spread of the target given the model of the region. Modeling comprises implementing an anisotropic three-dimensional Gaussian intensity model.

Determining the three-dimensional volume comprises determining a set of four-dimensional data points from the volumetric data, determining a bandwidth according to the determined center and spread of the target, and determining successive estimates of the center and spread that converge to a most stable center and spread. The most stable center and spread are determined by a Jensen-Shannon divergence profile.

Determining a three-dimensional volume is performed iteratively for clustering data points in the volumetric data according to spatial and intensity proximities simultaneously.

Determining a three-dimensional volume comprises a mean-shift ascent defining a basin of attraction of the target in a four-dimensional spatial-intensity joint space.

The center is determined according to a given marker, wherein the center is a point in the volumetric data to which the marker converges. The spread is determined as a covariance of the center.

According to an embodiment of the present disclosure, a program storage device is provided readable by machine, tangibly embodying a program of instructions executable by the machine to perform method steps for three-dimensional segmentation of a target in multislice images of volumetric data. The method steps comprising determining a center and a spread of the target by a parametric fitting of the volumetric data, and determining a three-dimensional volume by non-parametric segmentation of the volumetric data iteratively refining the center and spread of the target in the volumetric data.

### BRIEF DESCRIPTION OF THE DRAWINGS

Preferred embodiments of the present invention will be described below in more detail, with reference to the accompanying drawings:

FIGS. 1A-B illustrate 2D examples of the pulmonary nodule segmentation;

FIGS. 1C-D illustrate 2D examples of the pulmonary nodule segmentation according to an embodiment of the present disclosure;

FIG. 2 is a flow chart illustrating a method according to an embodiment of the present disclosure;

FIG. 3 is an illustration of a system according to an embodiment of the present disclosure;

FIG. 4A is a flow chart illustrating a method for center and spread estimation according to an embodiment of the present disclosure;

FIG. 4B is a flow chart illustrating a method for volume segmentation according to an embodiment of the present disclosure; and

FIGS. 5A-H are examples of 3D estimation and segmentation according to an embodiment of the present disclosure.

### DETAILED DESCRIPTION OF PREFERRED EMBODIMENTS

According to an embodiment of the present disclosure, a robust and accurate method for segmenting the 3D pulmonary nodules in multislice CT scans unifies the parametric Gaussian model fitting of the volumetric data evaluated in Gaussian scale-space and non parametric 3D segmentation based on normalized gradient (mean shift) ascent defining the basis of attraction of the target tumor in the 4D spatial-intensity joint space. This realizes the 3D segmentation according to both spatial and intensity proximities simultaneously. Experimental results show that the system and method reliably segment a variety of nodules including part- or non-solid nodules that poses difficulty for the existing solutions. The system and method also process a 32×32×32-voxel volume-of-interest efficiently by six seconds on average.

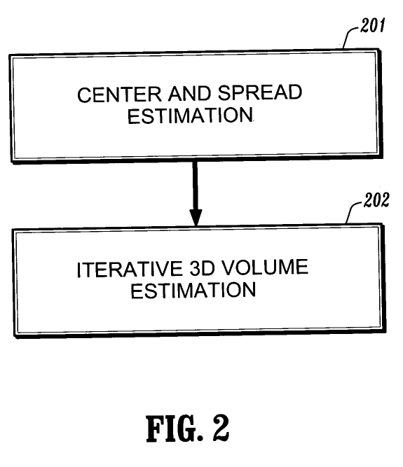

Referring to FIG. 2, the determination of 3D segmentation of volumes in multislice CT images includes 3D nodule center and spread estimation by fitting the anisotropic Gaussian intensity module in the Gaussian scale-space 201 and an iterative 3D nodule segmentation based on the basin of attraction in the 4D spatial-intensity joint space 202. The center and spread estimation provides the reliable parametric estimation of the nodule's anisotropic structure by robustly fitting a Gaussian intensity model in the Gaussian scale-space of the given data. The iterative 3D nodule segmentation provides the non-parametric 3D nodule segmentation, according to both spatial and intensity proximities simultaneously, by using the normalized gradient ascent-based data segmentation in the 4D joint space. The results from the center and spread estimation is interpreted as a normal prior and used to determine the analysis bandwidth of the latter step, resulting in an efficient segmentation solution. The joint-space segmentation that exploits the basin of attraction has provided a robust solution for the general image segmentation problem. However, the method has not been considered in the medical imaging domain and provides an alternative segmentation principle to the intensity thresholding.

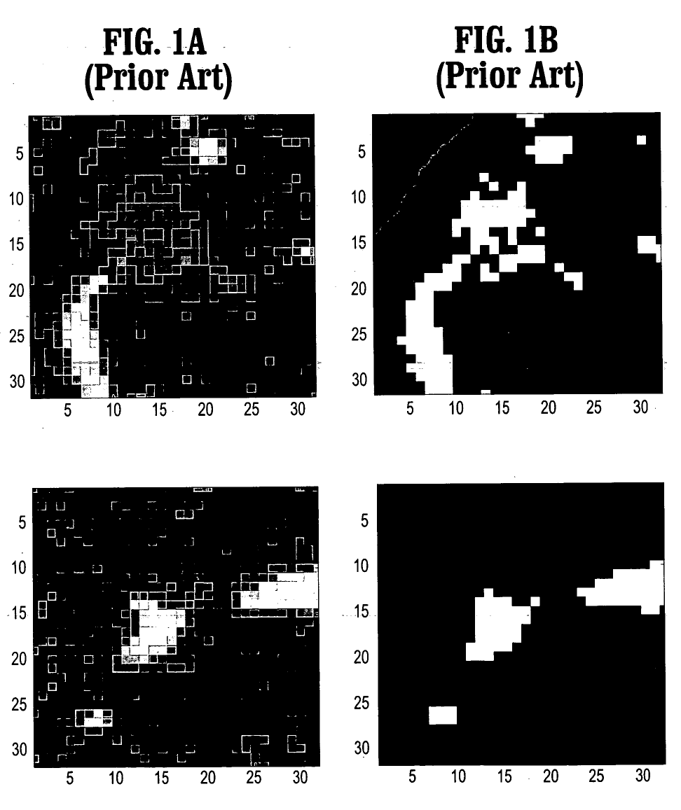

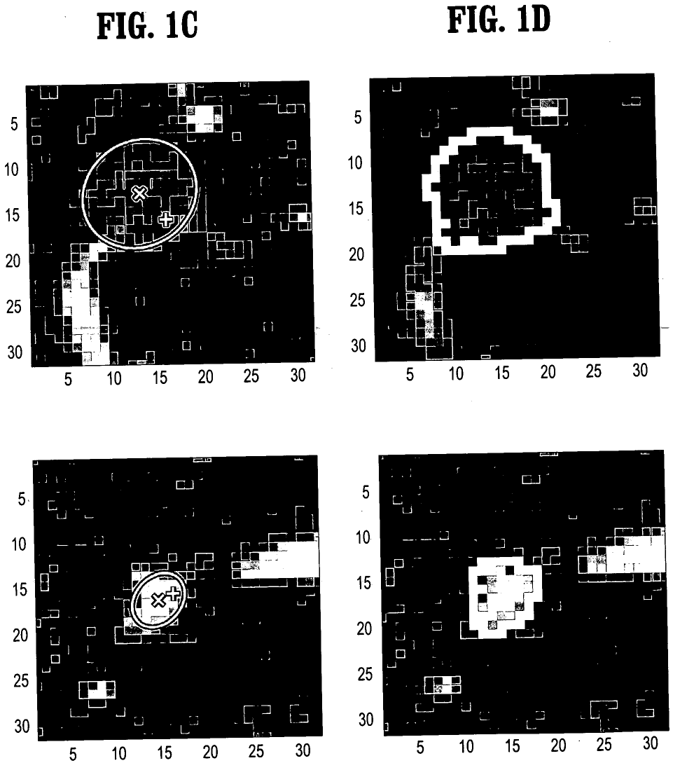

FIGS. 1C-D illustrate 2D examples of the pulmonary nodule segmentation. FIG. 1C: center (x) and anisotropic spread (ellipse) estimated according to an embodiment of the present disclosure (+ indicates the marker location xₚ), FIG. 1D: nodule segmentation result according to an embodiment of the present disclosure without any geometrical post-processing. The first row is an example of the part- and non-solid nodules while the second row is of the solid nodules.

It is to be understood that the present invention may be implemented in various forms of hardware, software, firmware, special purpose processors, or a combination thereof. In one embodiment, the present invention may be implemented in software as an application program tangibly embodied on a program storage device. The application program may be uploaded to, and executed by, a machine comprising any suitable architecture.

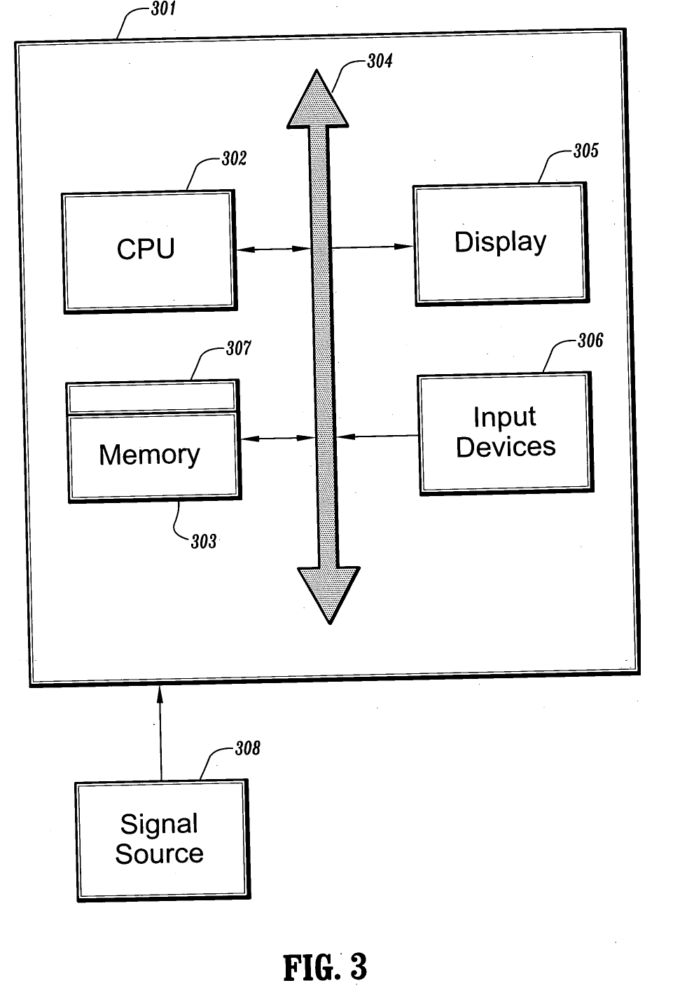

Referring to FIG. 3, according to an embodiment of the present disclosure, a computer system 301 for 3D segmentation of multislice images, inter alia, a central processing unit (CPU) 302, a memory 303 and an input/output (I/O) interface 304. The computer system 301 is generally coupled through the I/O interface 304 to a display 305 and various input devices 306 such as a mouse and keyboard. The support circuits can include circuits such as cache, power supplies, clock circuits, and a communications bus. The memory 303 can include random access memory (RAM), read only memory (ROM), disk drive, tape drive, etc., or a combination thereof. The present invention can be implemented as a routine 307 that is stored in memory 303 and executed by the CPU 302 to process the signal from the signal source 308, such as a CT scanner. As such, the computer system 301 is a general-purpose computer system that becomes a specific purpose computer system when executing the routine 307 of the present invention.

The computer platform 301 also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

It is to be further understood that, because some of the constituent system components and method steps depicted in the accompanying figures may be implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present invention.

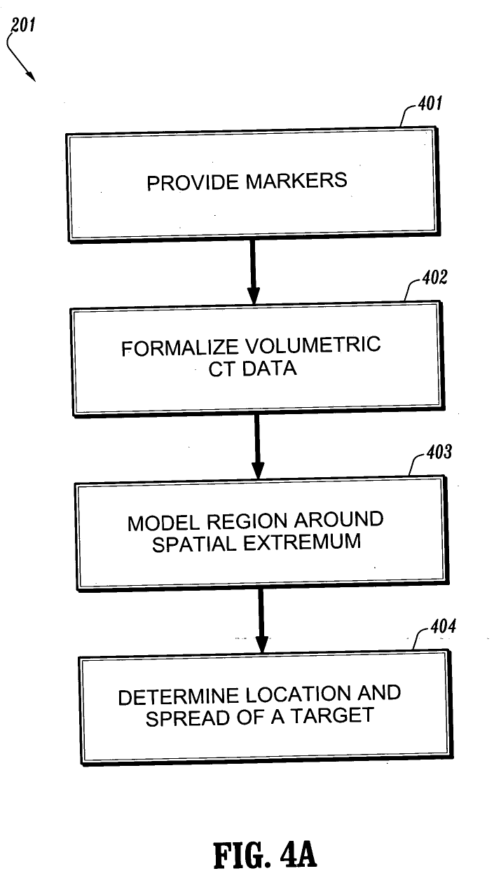

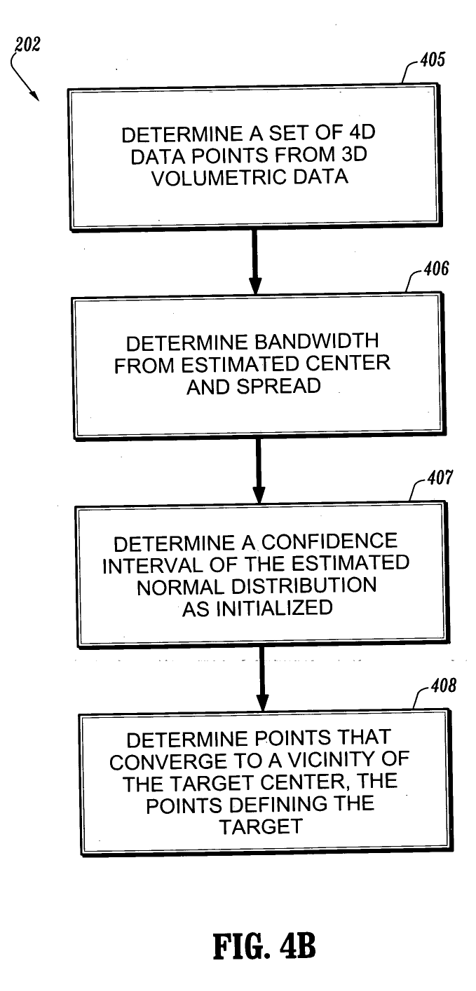

FIG. 4A illustrates 3D tumor center and anisotropic spread estimation by robust scale-space analysis includes an elimination method for 3D tumor center location and anisotropic spread. Assuming that a marker xₚ, indicating the rough location of the target tumor, is given a priori, such markers can be provided from an automatic tumor detection system or the screening results of radiologists 401. According to an embodiment of the present disclosure, the center and anisotropic spread estimation is based on the anisotropic 3D Gaussian intensity model fitting in the Gaussian scale-space.

The volumetric CT data is formalized 402 as a continuous positive function I:R₊³→R₊ over the data space X=(X₁X₂,X₃). A local region of I(x) around a spatial extremum u 403, expressing a pulmonary tumor, is modeled by the anisotropic 3D Gaussian intensity model,

$$\begin{matrix}I ( x ) ≃ α \times Φ ( x ; u , Σ ) {\vert}_{x ∈ S} , & ( 1 ) \\ Φ ( x ; u , Σ ) = {( 2 π )}^{- d / 2} {\vert Σ \vert}^{- 1 / 2} exp ( - \frac{1}{2} {( x - u )}^{t} {Σ}^{- 1} ( x - u ) ) & ( 2 )\end{matrix}$$

where α is an amplitude parameter, Σ is a fully-parameterized 3×3 symmetric positive definite covariance matrix, and S is a set of data points in the neighborhood of u, belonging to the basin of attraction of u. The mean u and covariance Σ of Φ describes the location and spread of a target 404, e.g., the tumor, respectively. Thus, the problem can be understood as parametric model fitting or robust estimation of (u,Σ) given I(x). Anisotropy of the tumor can be described by considering the estimation of the fully-parameterized covariance.

Multi-scale analysis is employed for this estimation, given a set of ordered and densely sampled analysis scales (bandwidth) {hₖ|k=1, . . . ,K}. The model mean and covariance are robustly estimated, by the method described below, for each analysis scale hₖ, resulting in a set of successive estimates {(uₖ,Σₖ)}. A result is given by finding the most stable estimate using a divergence-based stability test. The most stable estimate (u*,Σ*) is defined as the estimate with the scale hₖ* that assumes a local minimum of the modified Jensen-Shannon divergence profile over the scales. At each scale hₖ, the divergence is determined over three neighboring scales.

For each analysis bandwidth hₖ, (uₖ,Σₖ) are estimated by scale-space mean shift analysis together with the robust estimation technique based on the basin of attraction. Gaussian scale-space of I(x), or the solution of the diffusion equation ∂ₕI=½∇²I, is defined by a convolution of I(x) with a set of Gaussian kernels with the analysis scales {h>0}, L(x;H)=f(x)*φ(x;0,H), where H is an isotropic bandwidth matrix of a form H=hI. Its gradient vector is given by,

$$\begin{matrix}∇ L ( x ; H ) = I ( x ) * ∇ Φ ( x ; 0 , H ) = {H}^{- 1} L ( x ; H ) m ( x ; H ) & ( 3 ) \\ m ( x ; H ) ≡ \frac{\int {x}^{′} Φ ( x - {x}^{′} ; H ) f ( {x}^{′} ) ⅆ {x}^{′}}{\int Φ ( x - {x}^{′} ; H ) f ( {x}^{′} ) ⅆ {x}^{′}} - x = H \frac{∇ L ( x ; H )}{L ( x ; H )} & ( 4 )\end{matrix}$$

The vector m(x) is called scale-space mean shift vector and proportional to the gradient vector ∇L(x;H). A convergent iterative method for the normalized gradient ascent in the scale-space xₖ₊₁=m(xₖ)+xₖ, is used to estimate the tumor center uₖ, to which the given marker xₚ converges. To increase the robustness, a set of the gradient ascents are preformed from different initial points samples uniformly around xₚ. The convergence point of the majority of the initial points defines the center estimate uₖ.

Given the center estimate, the corresponding covariance Σₖ, is estimated. Substituting the Gaussian tumor model Eq.(1) to the definition of the scale-space mean shift Eq.(4) reveals that the mean shift can be expressed as a quasi-linear matrix equation, m(x;H)=H(Σ+H)⁻¹(u−x). An over complete set of the linear equations with unknown Σ is constructed by using the mean shift vectors sampled within the basin of attraction of the target tumor. For this, a set of the mean shift iterations are performed from different initial points that are sampled uniformly around the center estimate uₖ. Nᵤ mean shift ors along convergent trajectories are used for constructing the over complete system,
AΣ=B, ΣεSPD (5)
A=(m(x₁; H), . . . , m(x_{N}_{ᵤ}; H))^{t}H^{-t} (6)
B=(b₁, . . . ,b_{N}_{ᵤ})^{t}, bⱼ=uₖ−−xⱼ−m(xⱼ;H) (7)
where SPD denotes a set of all symmetric positive definite matrices in R^{3×}3. A closed-form solution of this constrained system may be given by minimizing an area criterion ∥AY−B^{-t}∥_{F}² where Y is Cholesky factorization of Σ=YY^{t} and ∥.∥_{F} is the Frobenius matrix norm. The solution may be expressed by a function of symmetric Schur decompositions of P=A^{t}A and \tilde{Q}=ΣₚUₚ^{t}QUₚΣₚ, given Q≡B^{t}B.

$$\begin{matrix}{Σ}_{k} = {U}_{P} {Σ}_{P}^{- 1} {U}_{\tilde{Q}} {Σ}_{\tilde{Q}} {U}_{\tilde{Q}}^{t} {Σ}_{P}^{- 1} {U}_{P}^{t} & ( 8 ) \\ P = {U}_{P} {Σ}_{P}^{2} {U}_{P}^{t} , & ( 9 ) \\ \tilde{Q} = {U}_{\tilde{Q}} {Σ}_{\tilde{Q}}^{2} {U}_{\tilde{Q}}^{t} & ( 10 )\end{matrix}$$

The robustness of the solution is endowed by using the information only within the basin of attraction, which effectively suppresses outliers.

This parametric estimation step yields the estimates of the 3D tumor center and tumor spread in the form of 3D mean vector u* and 3×3 covariance matrix Σ*. Also provided the bandwidth h* that yields the above estimate which are most stable among others. The center and spread estimates can be interpreted as the normal probability distribution g(x) of the center estimate,

$$g ( x ) = N ( x ; {u}^{*} , {Σ}^{*} ) = \frac{1}{{\vert 2 {πΣ}^{*} \vert}^{1 / 2}} exp ( - \frac{1}{2} {( x - {u}^{*} )}^{t} {Σ}^{* - 1} ( x - {u}^{*} ) ) \qquad ( 11 )$$

According to an embodiment of the present disclosure the non-parametric 3D nodule segmentation is based on defining the basin of attraction of the target nodule in the 4D spatial-intensity joint space (see FIG. 2, box 202). The method exploits the normal prior from the anisotropic spread estimation.

Referring to FIG. 4B, the special-intensity joint space is conceived by interpreting the 3D function as a set of data points in a 4D space. This is achieved by introducing, to the 3D data space xδR₊³, another orthogonal dimension for the distribution of the function responses, resulting in the joint space y≡(X,I(X)εR₊⁴. A volumetric CT data is a discretization of the function I(x) over a 3D regular lattice, resulting N data locations

$$\{ {x}_{i} ∈ {Z}_{+}^{3} \vert i = 1 , … , N \}$$

where N=II_{d=1}³=N_{d} and N_{d} is the number of voxels along the dimension d. Therefore, in the spatial-intensity joint space, the discretized samples {I(xᵢ)} are interpreted as a set of 4D data points {yᵢ≡(xᵢ,I(xᵢ)} 405. The sample density estimate with normal kernel with a 4×4 bandwidth matrix H (406, see below) is given at a data point y by,

$$f ( y ) = \frac{1}{N {\vert 2 π H \vert}^{1 / 2}} {\sum }_{i = 1}^{N} exp ( - \frac{1}{2} {( y - {y}_{i} )}^{t} {H}^{- 1} ( y - {y}_{i} ) ) \qquad ( 12 )$$

Consequently, the gradient of the density f(y) is given by,

$$\begin{matrix}∇ f ( y ) = \frac{1}{N {\vert 2 π H \vert}^{1 / 2}} {\sum }_{i = 1}^{N} {H}^{- 1} ( {y}_{i} - y ) \\ exp ( - \frac{1}{2} {( y - {y}_{i} )}^{t} {H}^{- 1} ( y - {y}_{i} ) ) & ( 13 ) \\ = {H}^{- 1} f ( y ) m ( y ) & ( 14 ) \\ m ( y ) ≡ \frac{{\sum }_{i = 1}^{N} {y}_{i} exp ( - \frac{1}{2} {( y - {y}_{i} )}^{t} {H}^{- 1} ( y - {y}_{i} ) )}{{\sum }_{i = 1}^{N} exp ( - \frac{1}{2} {( y - {y}_{i} )}^{t} {H}^{- 1} ( y - {y}_{i} ) )} - y = H \frac{∇ f ( y )}{f ( y )} & ( 15 )\end{matrix}$$

The vector m(y) is the density mean shift in the 4D joint space. A convergent iterative method for the normalized density gradient ascent is obtained by,
yₖ+1=m(yₖ)+yₖ (16)
The iterator Eq.(16) is employed to cluster the data points according to both spatial and intensity proximities simultaneously. The points belonging to the basin of attraction of the target nodule are detected by applying Eq.(16) from a set of initial points, sampled according to the normal prior in Eq.(11), until convergence at ∇f(y)=0. Initial points are sampled with a confidence interval of the 3D normal distribution between pₗₒ and pᵤₚ percentiles 407. The points that converge to the vicinity of (u*,m_{I}) are merged into a cluster that defines the target nodule 408. The points with the probability above pᵤₚ are also considered to be a part of the nodule. For each point yᵢ in the joint space, there is only one corresponding point xᵢ in the 3D data space. Thus, the cluster membership of yᵢ is directly associated with the data point xᵢ resulting in the segmentation of the tumor and background in the data space x.

This method achieves both robust segmentation without intensity thresholding and insensitivity to variation of the intensity range, in comparison with the global threshold-based approach. However, for achieving the robustness in the segmentation results, it is important that the kernel bandwidth H is set appropriately for a given data {I(x₁)}. H is determined by exploiting the normal prior 406. H is formed as a diagonal matrix with the most stable bandwidth h* and the variance estimate of the intensities of σ_{I}².
H=diag(h*, h*, h*, σ_{I}²) (17)
where σ_{I}² is given by the sample variance of the intensity values within a q-percentile confidence ellipsoid of the normal distribution g(x),

$${σ}_{I}^{2} = \frac{1}{{N}_{σ}} {\sum }_{i = 1}^{{N}_{σ}} {( I ( {x}_{i} ) - {m}_{I} )}^{2} {\vert}_{{x}_{i} ∈ \{ {x}_{i} \vert {( {x}_{i} - {u}^{*} )}^{t} {Σ}^{* - 1} ( {x}_{i} - {u}^{*} ) < c \}} \qquad ( 18 )$$

The sample means of the set of the intensity values and the number of voxels within the confidence ellipsoid are denoted by m_{I} and N_{σ}, respectively. The parameter c is directly derived from the specific choice of the percentile q. The segmentation procedure using Eq.(16) is carried out using the mean shift vectors computed with the resulting bandwidth matrix.

The segmentation methods have been evaluated with a database of clinical multislice chest CT scans with 1 mm²×1.5 mm slice thickness, containing 77 nodules of 14 patients. The size of the nodules ranges between 3 mm and 25 mm in diameter. The data is also provided with the markers xₚ and the classification labels for the part- or non-solid nodules given by radiologists. The database includes i) 6 cases of the part- or non-solid nodules, ii) 28 cases of small nodules whose size is less than 5 mm, iii) 20 cases of nodules attached to the pleural surface, iv) 12 cases of largely non-spherical (anisotropic) nodules. An implementation of the above method is instantiated with the following settings. For the scale-space anisotropic intensity model fitting, a set of 25 analysis scales h={0.5²,0.75², . . . ,6.5²} are used. For 4D joint space segmentation, the confidence limits for sampling the initial points and for estimating the sample intensity variance are set to pₗₒ=25%, pᵤₚ=75%, and q=75%, respectively.

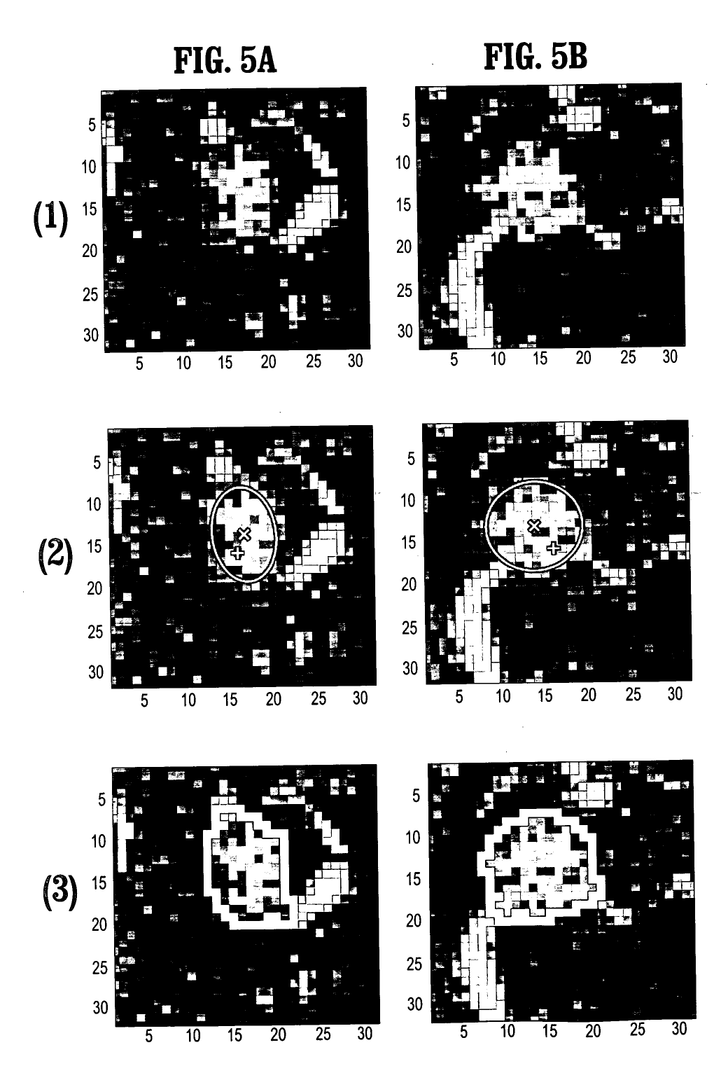

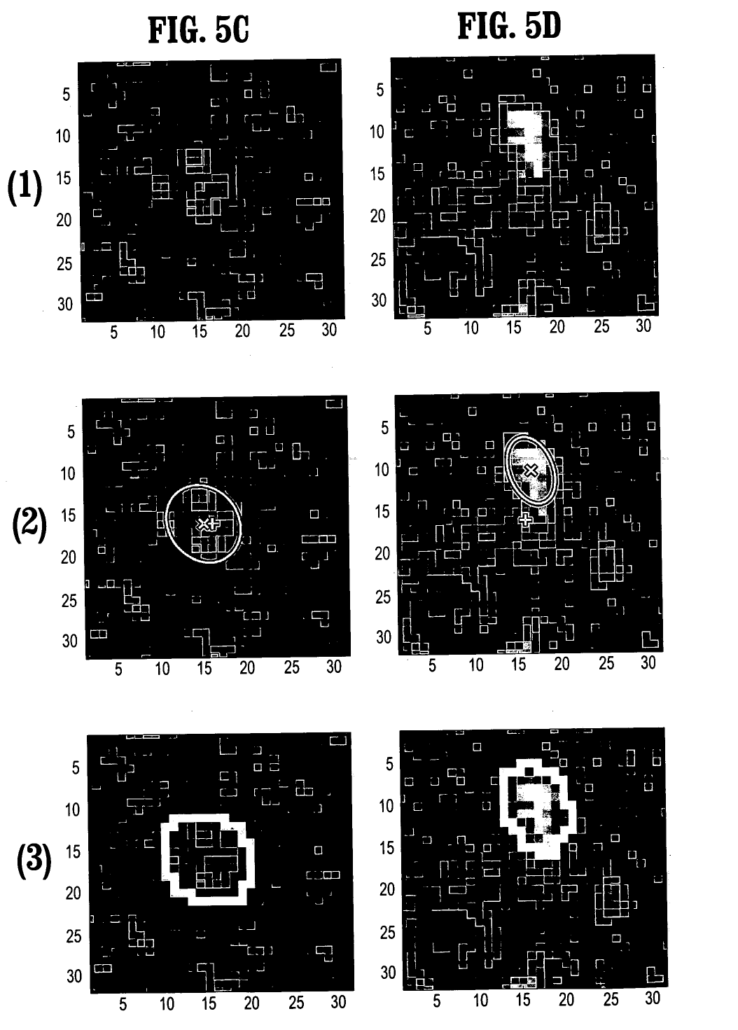

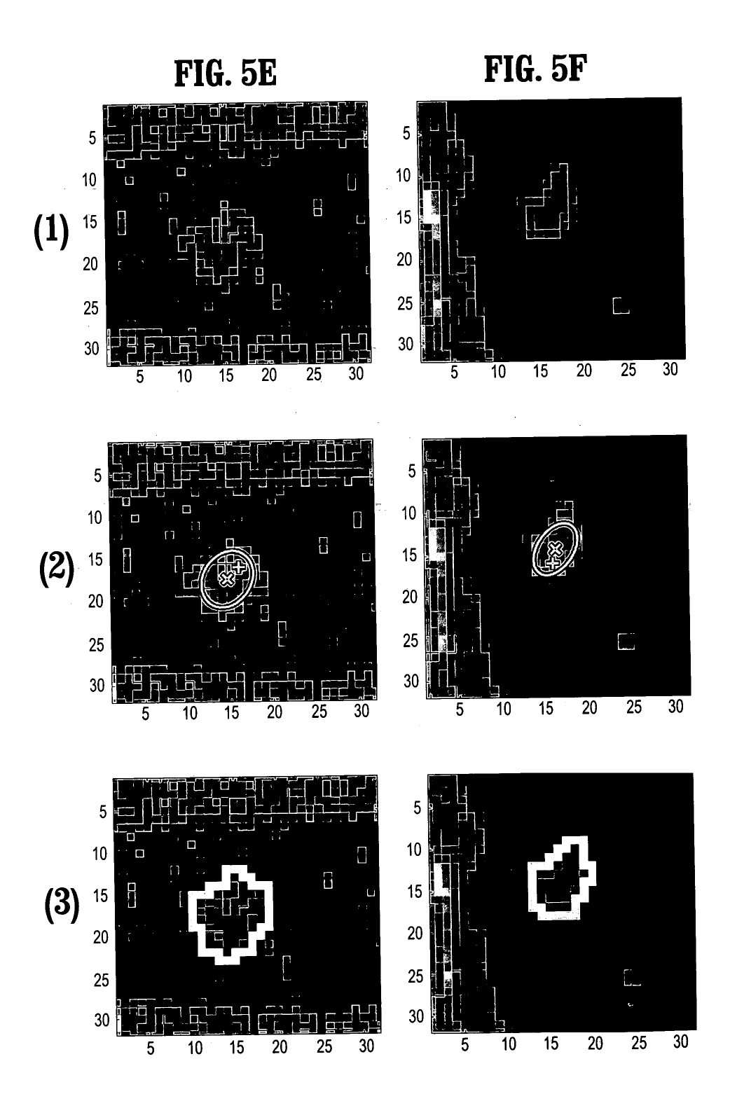

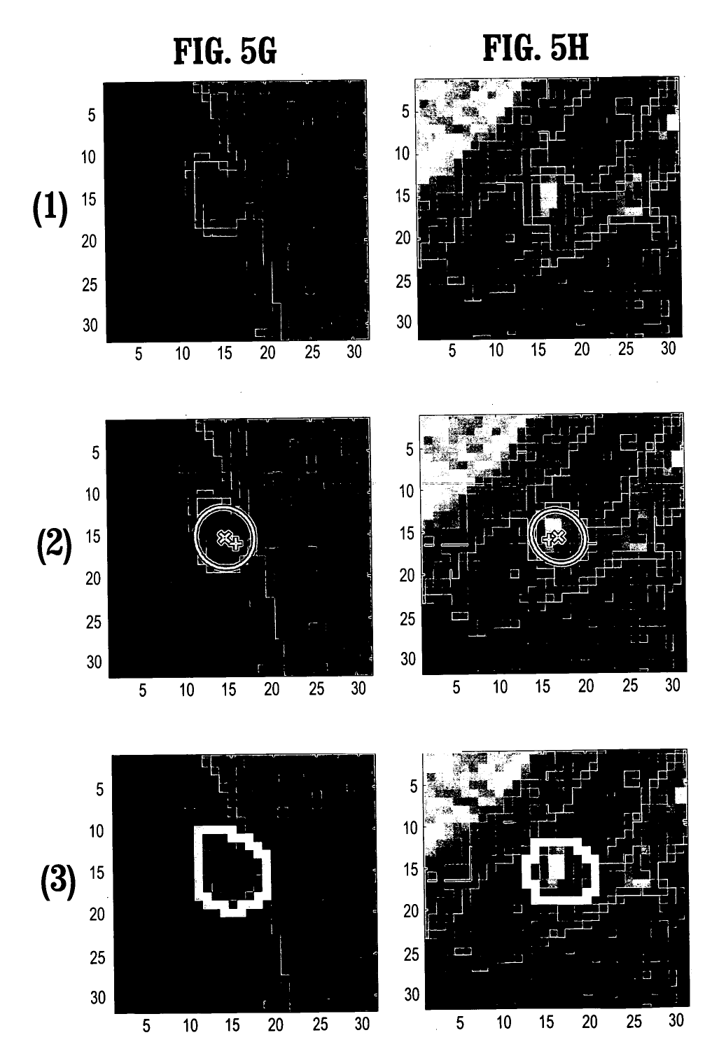

The performance evaluation of the system resulted in the correct parametric fits and non-parametric segmentations for 69 nodules by expert inspection. The 8 failures were due to i) small nodules attached to pleural surface (6 cases), ii) small vascularized nodule (1 case), iii) elongated nodule (1 case). All the part- or non-solid and solitary small nodules were correctly estimated and segmented. The rejection criterion based on chi-square residual analysis Eq.(9) is applied, resulting in successful rejection of all the failure cases attached to pleural surfaces. FIGS. 5A-H illustrate examples of the results. Each image is a 2D dissection of the target volume intersecting the estimated nodule center. The estimation results from the first step are visualized as an intersection of 50%-confidence ellipsoid of the normal prior Eq.(11). The system and method's sensitivity to the initial marker locations is reduced by randomly perturbing the markers within the 50%-confidence limit range, using 36 nodules. The average error of the mean and covariance estimates from total average of perturbation were 1.12 voxel and 8.21 Frobenius matrix norm, respectively. The results show the robustness against the uncertainty of marker location.

The robust and accurate methods for segmenting the 3D pulmonary nodules in multislice CT scans unify the parametric and non-parametric algorithms, realizing accurate and efficient 3D segmentation according to both spatial and intensity proximities simultaneously. Referring again to FIG. 2, the parametric model fitting 201 realizes robust characterization of the tumor's anisotropic structures, while the non-parametric segmentation 202 refines the results for finding more accurate 3D tumor boundary. Thus, reliable 3D segmentation may be achieved for a variety of nodules including the clinically significant small and part- or non-solid nodules. The system implemented in C language segments the nodules efficiently. It processes a 32-voxel cubic volume-of-interest 6 seconds on average using an off-the-shelf PC with a 2.4 GHz Intel CPU.

Referring to FIGS. 5A-H, examples of the 3D estimation and segmentation results are projected to a 2D plane for visualization. In each figure, row (1) depicts 2D profile of input nodules, row (2) depicts parametric fitting results (“+”:xₚ, “×”:u*,ellipse:Σ*), and row (3) depicts non-parametric segmentation results. FIGS. 5A-B depict non-solid targets, FIG. 5C depicts a part-solid target, FIGS. 5D-F depict anisotropic targets, and FIGS. 5G-H depict pleural attachments. Method flexibility refines the nodule shale approximated by Gaussian in row (2) to the non-parametric segmentation in row (3) (see FIGS. 5D-G). The method provides reliable segmentation even in the presence of neighboring structures (see FIGS. 5B, 5D, and 5G-H).

Having described embodiments for a system and method for 3D segmentation of targets in multislice images, it is noted that modifications and variations can be made by persons skilled in the art in light of the above teachings. It is therefore to be understood that changes may be made in the particular embodiments of the invention disclosed which are within the scope and spirit of the invention as defined by the appended claims. Having thus described the invention with the details and particularity required by the patent laws, what is claimed and desired protected by Letters Patent is set forth in the appended claims.

1. A method for three-dimensional segmentation of a target in multislice images of volumetric data comprising:
determining a center and a spread of the target by a parametric fitting of the volumetric data; and
determining a three-dimensional volume by non-parametric segmentation of the volumetric data iteratively refining the center and spread of the target in the volumetric data.

2. The method of claim 1, wherein determining the center and the spread of the target comprises:
providing a marker in the volumetric data for an initial target location;
determining a region around the initial target location;
modeling the region around a spatial extremum; and
determining the center and spread of the target given the model of the region.

3. The method of claim 2, wherein modeling comprises implementing an anisotropic three-dimensional Gaussian intensity model.

4. The method of claim 1, wherein determining the three-dimensional volume comprises:
determining a set of four-dimensional data points from the volumetric data;
determining a bandwidth according to the determined center and spread of the target; and
determining successive estimates of the center and spread that converge to a most stable center and spread.

5. The method of claim 4, wherein the most stable center and spread are determined by a Jensen-Shannon divergence profile.

6. The method of claim 1, wherein determining a three-dimensional volume is performed iteratively for clustering data points in the volumetric data according to spatial and intensity proximities simultaneously.

7. The method of claim 1, wherein determining a three-dimensional volume comprises a mean-shift ascent defining a basin of attraction of the target in a four-dimensional spatial-intensity joint space.

8. The method of claim 1, wherein the center is determined according to a given marker, wherein the center is a point in the volumetric data to which the marker converges.

9. The method of claim 8, wherein the spread is determined as a covariance of the center.

10. A program storage device readable by machine, tangibly embodying a program of instructions executable by the machine to perform method steps for three-dimensional segmentation of a target in multislice images of volumetric data, the method steps comprising:
determining a center and a spread of the target by a parametric fitting of the volumetric data; and
determining a three-dimensional volume by non-parametric segmentation of the volumetric data iteratively refining the center and spread of the target in the volumetric data.

11. The method of claim 10, wherein determining the center and the spread of the target comprises:
providing a marker in the volumetric data for an initial target location;
determining a region around the initial target location;
modeling the region around a spatial extremum; and
determining the center and spread of the target given the model of the region.

12. The method of claim 11, wherein modeling comprises implementing an anisotropic three-dimensional Gaussian intensity model.

13. The method of claim 10, wherein determining the three-dimensional volume comprises:
determining a set of four-dimensional data points from the volumetric data;
determining a bandwidth according to the determined center and spread of the target; and
determining successive estimates of the center and spread that converge to a most stable center and spread.

14. The method of claim 13, wherein the most stable center and spread are determined by a Jensen-Shannon divergence profile.

15. The method of claim 10, wherein determining a three-dimensional volume is performed iteratively for clustering data points in the volumetric data according to spatial and intensity proximities simultaneously.

16. The method of claim 10, wherein determining a three-dimensional volume comprises a mean-shift ascent defining a basin of attraction of the target in a four-dimensional spatial-intensity joint space.

17. The method of claim 10, wherein the center is determined according to a given marker, wherein the center is a point in the volumetric data to which the marker converges.

18. The method of claim 17, wherein the spread is determined as a covariance of the center.
